(19) United States
(12) Patent Application Publication
(10) Pub. No.: US 2021/0384659 A1
(43) Pub. Date: Dec. 9, 2021

(54) DIMM SOCKET CONNECTOR

(71) Applicant: Hewlett Packard Enterprise Development LP, Houston, TX (US)

(72) Inventors: Daniel W. TOWER, Houston, TX (US); Earl W. MOORE, Houston, TX (US); Kenny Huy PHAM, Houston, TX (US); Minh NGUYEN, Houston, TX (US)

(21) Appl. No.: 16/895,801

(22) Filed: Jun. 8, 2020

(51) Int. Cl. H01R 12/72; H01R 13/629

(52) U.S. Cl. CPC H01R 12/721; H01R 13/62988

(57) ABSTRACT

A system, comprising: a printed circuit board (PCB); and dual in-line memory module (DIMM) socket connectors, to connect to a top side of the PCB and a bottom side of the PCB, each DIMM socket connector including: a socket to accept a memory module; two latches located at opposite ends of the DIMM socket connector to secure a memory module; a first tab at one end of the DIMM socket connector including an aperture to allow for a fastener to pass through; and a second tab at the other end of the DIMM socket connector including an aperture with an insert to secure another fastener.

### BACKGROUND

Computing devices or servers utilize memory. A certain amount of dual in-line memory module (DIMM) socket connectors (to accept memory) may be added to computing devices or servers based on motherboard real estate and the amount of memory computationally supported by the computing device or server. To physically increase the amount of memory in a computing device or server, based on the size of the motherboard, DIMM socket connectors may be added to both sides of the motherboard. However, this is not possible in various configurations due to through-hole locking solder tabs located at both ends of a DIMM socket connector. Further, the tension or force placed on DIMM socket connectors by connection points to the motherboard may cause the DIMM socket connectors to break.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a block diagram of a system including a PCB and a DIMM socket connector;

FIGS. 2A-D are schematic views of a PCB with DIMM socket connectors;

FIGS. 3A-B are schematic views of a DIMM socket connector; and

FIG. 4 is a flow chart for attaching a DIMM socket connector to a PCB.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Computing devices or servers utilize memory. A certain amount of dual in-line memory module (DIMM) socket connectors (to accept memory) may be added to computing devices or servers based on motherboard real estate and the amount of memory computationally supported by the computing device or server. To physically increase the amount of memory in a computing device or server, based on the size of the motherboard, DIMM socket connectors may be added to both sides of the motherboard. However, this is not possible in various configurations due to through-hole locking solder tabs located at both ends of a DIMM socket connector. Further, the tension or force placed on DIMM socket connectors by some types of rigid connection points to the motherboard may cause the DIMM socket connectors to break.

For example, one configuration may be one DIMM socket connector positioned directly above or below another DIMM socket connector (as in, one DIMM socket connector on the top or obverse of a motherboard and another DIMM socket connector on the bottom or reverse, the bottom DIMM socket connector directly below the DIMM socket connector on the top or obverse of the motherboard). In another configuration the DIMM socket connectors on the top may be staggered, as compared to the DIMM socket connectors on the bottom. In both examples, the DIMM socket connectors adjacent to other DIMM socket connectors may abut. In other words, there may be no space or a small gap between each DIMM socket connector. In such examples, the typical through-hole locking solder tab may not be utilized, as the DIMM socket connectors opposite the other DIMM socket connectors may prevent or block such a through-hole locking solder tab.

Based on the issues described above, one solution is too loosely but securely couple each DIMM socket connector to a PCB or the motherboard. In such examples, rather than coupling or attaching the non-signal connection point (as noted above, the through-hole locking solder tab) to the PCB or motherboard, the DIMM socket connector may be mechanically coupled to the opposite DIMM socket connector (as in, the DIMM socket connector disposed on the opposite side of the PCB or motherboard). In such examples, the DIMM socket connectors may include a first tab at one end and a second tab at the other end. In such examples, the first tab may include an aperture to allow for passage of a fastener. Further, the second tab may include an insert to retain a fastener from the other side of the PCB or motherboard (and associated with the opposite DIMM socket connector). In such examples, the first tab and second tab may align with apertures in the PCB or motherboard.

For example, the fastener may be a screw and the insert may be a threaded insert corresponding to the screw. In such examples, a user may insert the screw into the aperture of the first tab of a first DIMM socket connector. The user may then proceed to tighten the screw in the threaded insert of a second tab of a second DIMM socket connector opposite the first DIMM socket connector. Further, a user may insert the screw into the aperture of the first tab of the second DIMM socket connector and may proceed to tighten the screw in the threaded insert of the second tab of the first DIMM socket connector. In such examples, the first tab and second tab of the first DIMM socket connector and of the second DIMM socket connector may sit flush against the PCB or motherboard. Thus, the first DIMM socket connector and the second DIMM socket connector may be loosely fastened to the PCB or motherboard (via connection by fastener between the first tab of a DIMM socket connector and second tab of another DIMM socket connector).

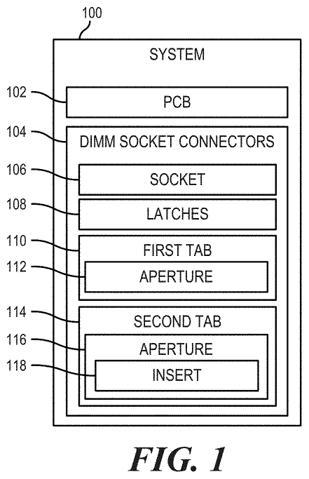

FIG. 1 is a block diagram of a system 100 including a PCB 102 and DIMM socket connectors 104. In an example, system 100 may include a PCB 102. In another example, the system 100 may include DIMM socket connectors 104. In another example, the DIMM socket connectors 104 may attach to a top side and bottom side of the PCB 102. In another example, each one of the DIMM socket connectors 104 may include a socket 106 to accept a memory module (or some other machine-readable storage medium), two latches 108 disposed and located at opposite ends of each of the DIMM socket connectors 104 to secure a memory module (or some other machine-readable storage medium), a first tab 110 at one end of each of the DIMM socket connectors 104, and a second tab 114 at the other end of each of the DIMM socket connectors 104. In another example, the first tab 110 may include an aperture 112 to allow for a fastener (such as a screw) to pass through. In another example, the second tab 114 may include an aperture 116 with an insert 118 (for example, a threaded insert to accept screws) to secure another fastener.

As used herein, a “computing device” may be a storage array, storage device, storage enclosure, server, desktop or laptop computer, networking device, switch, access point, or any other device or equipment including a controller, a processing resource, or the like. In examples described herein, a “processing resource” may include, for example, one processor or multiple processors included in a single computing device or distributed across multiple computing devices. As used herein, a “processor” or “processing resource” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution instructions stored on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive, hard drive disk (HDD)), a solid state drive, any type of storage disc (e.g., a compact disc, a DVD, etc.), and the like, or a combination thereof. In another example, the machine-readable storage medium may fit into a space on a computing device.

As used herein, “rack unit” or “U” may refer to the unit of measurement to define the height of a rack frame and the height of the equipment in a rack frame (such as, computing devices). Each rack unit may be equivalent to 44.50 millimeters or 1.75 inches. For example, a computing device, such as a rack server, may have a height of 2U or 2 rack units (in other words, 89 millimeters or 3.5 inches).

As noted above, FIG. 1 is a block diagram of a system 100 including a PCB 102 and DIMM socket connectors 104. As noted above the PCB 102 may be a motherboard, a part of a motherboard, or integral to a motherboard. In another example, the PCB 102 may be separate from a motherboard. In such examples, the PCB 102 may include an edge connector electrically connected to the DIMM socket connectors 104. Further, the edge connector may be a peripheral component interconnect express (PCIe) connector, DIMM connector, or some other similar connector. In another example, the PCB 102 may include a port to allow for a cable to attach to, the cable to further attach to a port on the system 100

In another example, the PCB 102 may include an area on the top side or obverse side with traces for a number of the DIMM socket connectors 104 and an area on the bottom side or reverse side with traces for a number of the DIMM socket connectors 104. In an example, the amount of traces for the DIMM socket connectors 104 on the top or obverse side of the PCB 102 are the same as the amount on the bottom or reverse side of the PCB 102. In an example, the traces may be arranged in such a way that a top DIMM socket connector is positioned above a bottom DIMM socket connector. Stated another way, the top DIMM socket connectors may be parallel to the bottom DIMM socket connectors.

As noted above, latches 108 may be disposed on both ends of each of the DIMM socket connectors 104. The latches 108 may be pulled back to allow for insertion of memory modules (or other machine-readable storage medium) into socket 106. After insertion of memory modules (or other machine-readable storage medium) into socket 106, the latches 108 may return to a resting position and may retain the memory modules (or other machine-readable storage medium).

As noted above, each of the DIMM socket connectors 104 may include a first tab 110 and, as noted, the first tab 110 may include an aperture 112. The fastener may pass through the aperture 112 and through a corresponding aperture on the PCB 102 to another tab on another DIMM socket connector (located on the other side of the PCB 102). The other tab may be a second tab 114 of another DIMM socket connector. In such examples and as noted above the second tab 114 may include an insert 118 in the aperture 116. The insert 118 may retain the fastener. For example, the fastener may be a screw. In such examples, the first tabs 110 aperture 112 may be large enough to allow the shank of the screw to pass through, while the head of the screw is larger than the aperture 112, thus preventing over-insertion. Further, the insert 118 may be a threaded insert. Thus, the screw may be attached to or threaded into the threaded insert.

In another example, the system 100 may be a computing device. In another example, the computing device may be a 1U, 2U, 4U, larger, or smaller server. For smaller servers, such as a 1U server, space may be limited inside the server. The dual sided PCB 102 may save space, while allowing for a denser memory configuration. In other words and as noted above, the DIMM socket connectors 104 may be disposed on both sides of the PCB 102 allowing for more memory in a smaller space. In an example, more than one of the DIMM socket connectors 104 may connect to either side of the PCB 102. In such examples, the amount of DIMM socket connectors 104 may be subject to the area of the PCB designated for memory (or another type of machine-readable storage medium).

In another example, the DIMM socket connectors 104 may include pins connected to the socket 106 to transfer power and data signals from and to memory (inserted into the socket 106) to and from other components of the system 100, such as a processor. In another example, the pins may connect to the traces on the PCB 102. In a further example, the pins may connect to the traces on the PCB 102 via a press fit connection or surface mount connection.

In another example, the fastener may be a screw. In such examples, the insert may be a threaded insert to accept the screw. In another example, the fastener may be a latch. In such examples, the insert 118 may be a corresponding retention mechanism. In another example, the fastener may be a pin or a push-pin. In such examples, the insert 118 may include a corresponding retention mechanism. For example, the insert 118 may hold the pin in place via friction. In another example, the insert 118 may be a retention mechanism that locks the pin or push-pin in place. For example, a push-pin may be pushed once into the retention mechanism to lock the push-pin into place and may be pushed a second time to unlock the push-pin.

In another example, the first tab 110 and second tab 114 may be integral to each of the DIMM socket connectors 104. In a further example, the first tab 110 and second tab 114 may include support structures. each DIMM socket connector

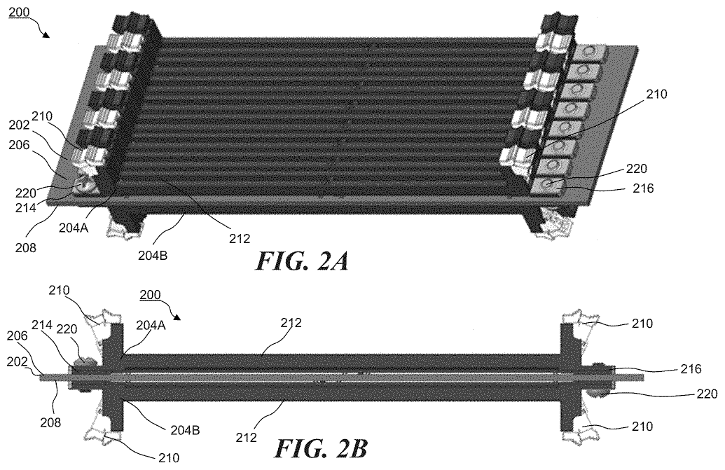

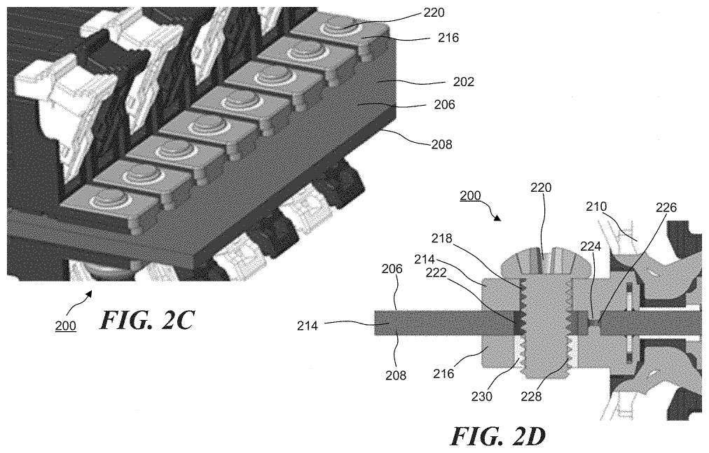

FIGS. 2A-D are schematic views of a PCB 202 with DIMM socket connectors 204. In such examples, the PCB 202 shown may be a portion of an overall PCB or motherboard. In another example, the PCB 202 shown may be a component separate from the motherboard. In such examples, the PCB 202 may include an edge connector or a port for a cable to connect to and further connect to a motherboard.

In another example, the DIMM socket connectors 204 on the PCB 202 may abut or be situated adjacent to each other on each side of the PCB 202, the top side 206 or obverse side and the bottom side 208 or reverse side. In such examples, the DIMM socket connectors 204 may be closely positioned to each other, but not touch (in other words, two adjacent DIMM socket connectors 204 may form a gap). In another example, each of the DIMM socket connectors 204 may abut each other and adjacent DIMM socket connector. In another example, DIMM socket connectors 204 may be disposed on both sides (the top side 206 or bottom side 208) of the PCB 202. In such examples, a set of the DIMM socket connectors 204A may be disposed on a top side 206 of the PCB 202 opposite another set of DIMM socket connectors 204B on the bottom side 208 of the PCB 202. In another example, the DIMM socket connectors 204A on the top side 206 of the PCB 202 may be disposed in a staggered pattern relative to the DIMM socket connectors 204B disposed on the bottom side 208 of the PCB 202.

In another example, the DIMM socket connectors 204 may include latches 210 to allow insertion of memory modules (or other machine-readable storage medium) into the socket 212. Further, the latches 210 may retain the memory modules (or other machine-readable storage medium) in the socket 212.

In another example, each of the DIMM socket connectors 204 may include a first tab 214 and a second tab 216. The first tab 214 may include an aperture 218 to allow for insertion of a fastener, for example, a screw 220. In such examples, the aperture 218 of the first tab 214 may align with an aperture 222 in the PCB 202. In another example, the first tab 214 may include a locating feature 224. In such examples, the locating feature 224 may correspond to an indention or aperture 226 on the PCB 202. In such examples, the locating feature 224 may be a protrusion from the first tab 214 to fit into the indention or aperture 226 of the PCB 202. In such examples, the locating feature 224 may allow for properly aligned insertion or installation of the DIMM socket connector 204 onto the PCB 202.

As noted, each of the DIMM socket connectors 204 may include a second tab 216. The second tab 216 may include an aperture 228. The aperture 228 may include an insert. For example, the fastener, as noted above, may be a screw 220 and the insert may be a threaded insert 230. In such examples, as the screw 220 is inserted into the aperture 218 of the first tab 214, through the aperture 222 in the PCB 202 and into the threaded insert 230, the screw 220 may be tightened or turned clockwise to tighten or thread the screw 220 in the threaded insert 230. In another example, the fastener may be a latch, a push-pin, a pin, a clip, or some other suitable fastener. In such examples, the insert may correspond to the type of fastener, for example, an anchor, a friction-based retention feature, a lock, or some other suitable retention feature. In another example, the second tab 216 may include a locating feature 232. In such examples, the locating feature 232 may correspond to an indention or aperture 226 on the PCB 202. In such examples, the locating feature 232 may be a protrusion from the second tab 216 to fit into the indention or aperture 226 of the PCB 202. In such examples, the locating feature 232 may allow for properly aligned insertion or installation of the DIMM socket connector 204 onto the PCB 202.

In another example, the DIMM socket connector 204 may be a press fit connector or surface mount connector. In some examples, after securing each of the DIMM socket connectors 204A to the top side 206 of the PCB 202 and securing a corresponding and/or opposite DIMM socket connector 204B to the bottom side 208 of the PCB 202, the DIMM socket connectors 204 may be soldered in place. In one example, the DIMM socket connectors 204 may be soldered via a wave solder process. In another example, the DIMM socket connectors 204 may be soldered to the PCB 202, then secured to the PCB 202 (via the first tab 214, the second tab 216, the fastener, and the insert).

In another example, the DIMM socket connectors 204 may be comprised of plastic. In another example, the first tab 214 and the second tab 216 may be plastic or metal. In another example, the fastener (e.g., a screw 220) and insert (e.g., threaded insert 230) may be comprised of the same or different material. In another example, the fastener may be comprised of metal or plastic and the insert may be comprised of metal or plastic.

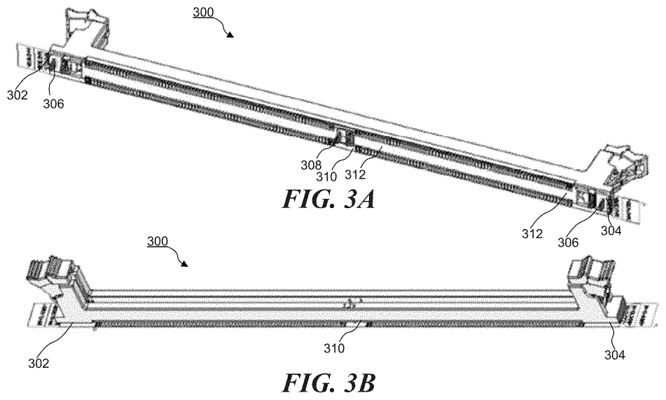

FIGS. 3A-B are schematic views of a DIMM socket connector 300. In another example, rather than the first tab including an aperture and the second tab including aperture with an insert to accept a fastener, both the first tab 302 and second tab 304 may include a fastener 306. In such examples, the fastener may be a press-fit fastener or some other suitable fastener.

In another example, the DIMM socket connector 300 may utilize an extra fastener 308 (e.g., an extra press-fit fastener). In such examples, the extra fastener 308 may be located at the midpoint 310 and at the bottom 312 of the DIMM socket connector 300. In such examples, the extra fastener 308 may be a press-fit fastener. In another example, the extra fastener 308 may be the same or different than the fasteners 306 included on the first tab 302 and the second tab 304.

In another example, the first tab 302 and second tab 304 may be integral to the DIMM socket connector 300 or may be added to the DIMM socket connector 300. In such examples, the DIMM socket connector 300 may include a portion to allow for the proper type of tab to be slid in place. For example, a screw may be utilized, while in another example, a press fit connection may be utilized. In another example, the first tab 302 and the second tab 304, when the DIMM socket connector 300 is added to a PCB, may sit flush against or abut the PCB. In another example, the first tab 302 and second tab 304 may sit lower than the bottom 312 of the rest of the DIMM socket connector 300.

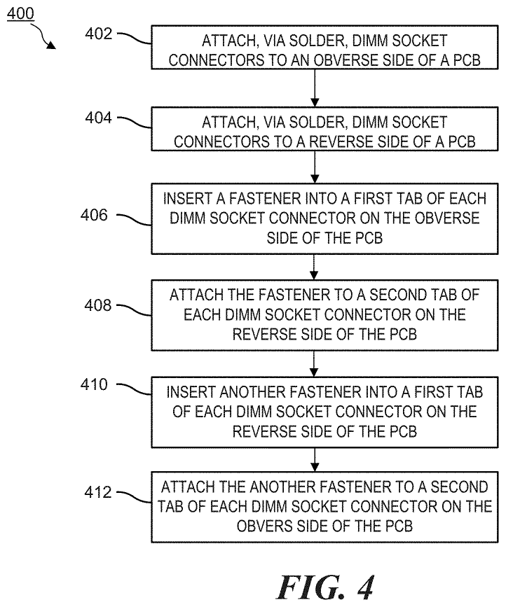

FIG. 4 is a flow chart for attaching a DIMM socket connector to a PCB. Although execution of method 400 is described below with reference to the system 200 of FIGS. 2A-D, other suitable systems or modules may be utilized, including, but not limited to, system 100 or DIMM socket connector 300. Additionally, implementation of method 400 is not limited to such examples.

At block 402, DIMM socket connectors 204A may be attached, via solder, to an obverse side or top side 206 of a PCB 202. In another example, a fastener may attach the DIMM socket connectors 204A on the obverse side or top side 206 to DIMM socket connectors 204B on the reverse side or bottom side 208 first, rather than via solder first. In another example, the DIMM connector sockets 204 are soldered onto the PCB 202 first.

At block 404, DIMM socket connectors 204B may be attached, via solder, to a reverse side or bottom side 208 of the PCB 202. In another example, a fastener may attach DIMM socket connectors 204B on the reverse side or bottom side 208 to DIMM socket connectors 204A on the obverse side or top side 206 first, rather than via solder first. As noted and in another example, the DIMM connector sockets 204 are soldered onto the PCB 202 first.

At block 406, the fastener (e.g., screw 220) may be inserted into a first tab 214 of each of the DIMM socket connectors 204A on the obverse side or top side 206 of the PCB 202. In such examples, after the fastener (e.g. screw 220) passes through the first tabs 214 aperture 218, the fastener (e.g., screw 220) may pass through an aperture 222 in the PCB 202. At block 408, after the fastener (e.g., screw 220) is passed through the first tabs 214 aperture 218 and through the PCBs 202 aperture 222, the fastener (e.g., screw 220) may attach to the insert (e.g., threaded insert 230) in the aperture 228 of the second tab 216 of each of the DIMM socket connectors 204B on the reverse side or bottom side 208 of the PCB 202.

At block 410, another fastener (e.g., screw 220) may be passed through the aperture 218 of the first tab 214 of the DIMM socket connectors 204B located on the reverse side or bottom side 208 of the PCB 202. At block 412, the fastener (e.g., screw 220) may be attached to the insert (e.g., threaded insert 230) of the aperture 228 of the second tab 216 of each of the DIMM socket connectors 204A of the obverse side or top side 206.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims

What is claimed is:

1. A system, comprising:
a printed circuit board (PCB); and
dual in-line memory module (DIMM) socket connectors, to connect to a top side of the PCB and a bottom side of the PCB, each DIMM socket connector including:
a socket to accept a memory module;
two latches located at opposite ends of the DIMM socket connector to secure a memory module;
a first tab at one end of the DIMM socket connector including an aperture to allow for a fastener to pass through; and
a second tab at the other end of the DIMM socket connector including an aperture with an insert to secure another fastener.

2. The system of claim 1, wherein the DIMM socket connector is a press-fit connector.

3. The system of claim 1, wherein the DIMM socket is a surface mount connector.

4. The system of claim 1, wherein the fastener is a screw and the insert is a threaded insert to accept the screw.

5. The system of claim 1, wherein the fastener is a latch and the insert corresponds to the latch to secure the fastener.

6. The system of claim 5, wherein the latch is a press-fit latch.

7. The system of claim 1, wherein each DIMM socket connector includes a press-fit latch underneath and at the mid-point of the DIMM socket connector.

8. The system of claim 1, wherein each tab includes a locating feature.

9. The system of claim 8, wherein the locating feature corresponds to an indention on the PCB to ensure proper alignment and insertion onto the PCB of the DIMM socket connector.

10. A DIMM socket connector, comprising:
a socket;
a latch at a first end and at a second end of the DIMM socket connector; and
a first tab, included at the first end and extending past the latch at the first end, including a fastener to attach the DIMM socket connector to a PCB, wherein, when the DIMM socket connector is added to the PCB, the first tab abuts the PCB.

11. The DIMM socket connector of claim 10, further comprising:
a second tab, included at the second end and extending past the latch at the second end, including an aperture to secure another fastener corresponding to another DIMM socket connector attached to the obverse of the PCB, wherein, when the DIMM socket connector is added to the PCB, the second tab abuts the PCB.

12. The DIMM socket connector of claim 11, wherein the another fastener is inserted into an aperture of another first tab of the another DIMM socket connector.

13. The DIMM socket connector of claim 11, wherein the aperture includes a threaded insert.

14. The DIMM socket connector of claim 11, further comprising a latch at the mid-point and underneath the DIMM socket connector to connect to the PCB.

15. The DIMM socket connector of claim 14, wherein the latch at the mid-point and underneath the DIMM socket connector corresponds to a retention feature included on the PCB.

16. The DIMM socket connector of claim 11, wherein the first tab and second tab include a locating feature corresponding to an indention on the PCB to allow for proper alignment and insertion of the DIMM socket connector.

17. A method, comprising:
attaching, via solder, DIMM socket connectors to an obvers side of a PCB;
attaching, via solder, DIMM socket connectors to a reverse side of the PCB;
inserting a fastener into a first tab of each DIMM socket connector on the obverse side of the PCB;
attaching the fastener to a second tab of each DIMM socket connector on the reverse side of the PCB;
inserting another fastener into a first tab of each DIMM socket connector on the reverse side of the PCB; and
attaching the another fastener to a second tab of each DIMM socket connector on the obvers side of the PCB.

18. The method of claim 17, wherein each DIMM socket connector on both sides of the PCB are aligned via locating features on each first tab and second tab of each DIMM socket connector on both sides of the PCB.

19. The method of claim 18, wherein the locating feature is a protruding portion of each first tab and each second tab.

20. The method of claim 19, wherein the protruding portion corresponds to an indention on the PCB.
